(19) United States
(12) Patent Application Publication
(10) Pub. No.: US 2011/0308298 A1
(43) Pub. Date: Dec. 22, 2011

(54) DETECTING A LOW PRESSURE GAS FEEDING CONDITION IN AN ANALYSIS INSTRUMENT

(75) Inventors: Andrea Magni, Rodano (MI) (IT); Paolo Magni, Rodano (MI) (IT)

(73) Assignee: THERMO FISHER SCIENTIFIC S.P.A., Rodano (IT)

(21) Appl. No.: 13/144,814

(22) PCT Filed: Jan. 21, 2009
(86) PCT No.: PCT/IT09/00016

§ 371 Date: Sep. 6, 2011

(51) Int. Cl. G01N 30/02

(52) U.S. Cl. 73/23.35

(57) ABSTRACT

This invention concerns a method and a gas chromatographic instrument in which a gas feeding low pressure condition, for instance from a cylinder, is monitored by controlling an electric parameter operating on a proportional solenoid valve placed along the gas line, and wherein an alarm to the operator is foreseen when said parameter reaches a pre-set value, so to allow a cylinder substitution before the pressure falling to zero.

### FIELD OF THE INVENTION

This invention relates to a method for detecting a gas feeding low pressure condition in an analysis instrument as a gas chromatographic instrument (GC) or an instrument formed by a gas chromatograph and a mass spectrometer (MS) having a gas line, in particular a carrier gas line fed by a cylinder or a generator and comprising a proportional solenoid valve to control the gas pressure and/or flow rate fed to the instrument.

The invention further relates to an analysis instrument, as a gas chromatograph or a gas chromatograph +mass spectrometer, having means to carry out the above mentioned method.

### BACKGROUND OF THE INVENTION

Many GC columns as well as some GC detectors and MS detectors are sensitive to air particularly at high temperature (operation temperatures). For this reason in case of loss of carrier gas a GC needs to automatically shut down all heated zones. This is an unpleasant situation since it may cause several hours of system downtime.

In case of a GC +MS system, the column outlet is connected to a vacuum chamber and air will be sucked into the MS detector through the column with negative effects on both the column and detector.

Considering what above, the object of this invention is to prevent a GC system to shut down in case of a low pressure feeding condition, providing an alarm to the operator prior than the cylinder or generator pressure drops to a value unsuitable to the GC operation. Operator will have, such a way, the time to switch to a full cylinder or generator without the need of shutting down GC temperatures. Modern GCs use electronic pressure and/or flow regulators to control carrier gas and other auxiliary gases. Electronic gas controllers make use of proportional solenoid valves. These valves have, essentially, a variable orifice that controls the flow of gas in proportion to the voltage (or to the input current) applied to the coil. Valves are normally used in a closed loop with a pressure or flow sensor to set the desired pressure or flow to the GC inlet system. This invention exploits the above stated features of the already installed proportional solenoid valves operating on the carrier gas feeding line.

### SUMMARY OF THE INVENTION

Accordingly, the new method is acted upon by monitoring an electric parameter applied to said proportional solenoid valve and by providing an alarm to the operator when said parameter reaches a pre-set value.

The gas chromatographic instrument to carry out the above stated method comprises a detector for monitoring an electric parameter applied to said proportional solenoid valve and alarm means adapted to operate when a pre-set value of said electric parameter is reached.

### BRIEF DESCRIPTION OF THE DRAWINGS

The above and further features of this invention will be now described with reference to an example of the same, with the help of the accompanying figures, wherein:

FIG. 1 is a diagrammatic view of a standard example showing a possible configuration of pneumatic layout in a conventional gas chromatographic instrument.

FIG. 2 shows the changes of the voltage applied to a proportional solenoid valve when the input pressure changes.

### DESCRIPTION OF THE PREFERRED EMBODIMENT

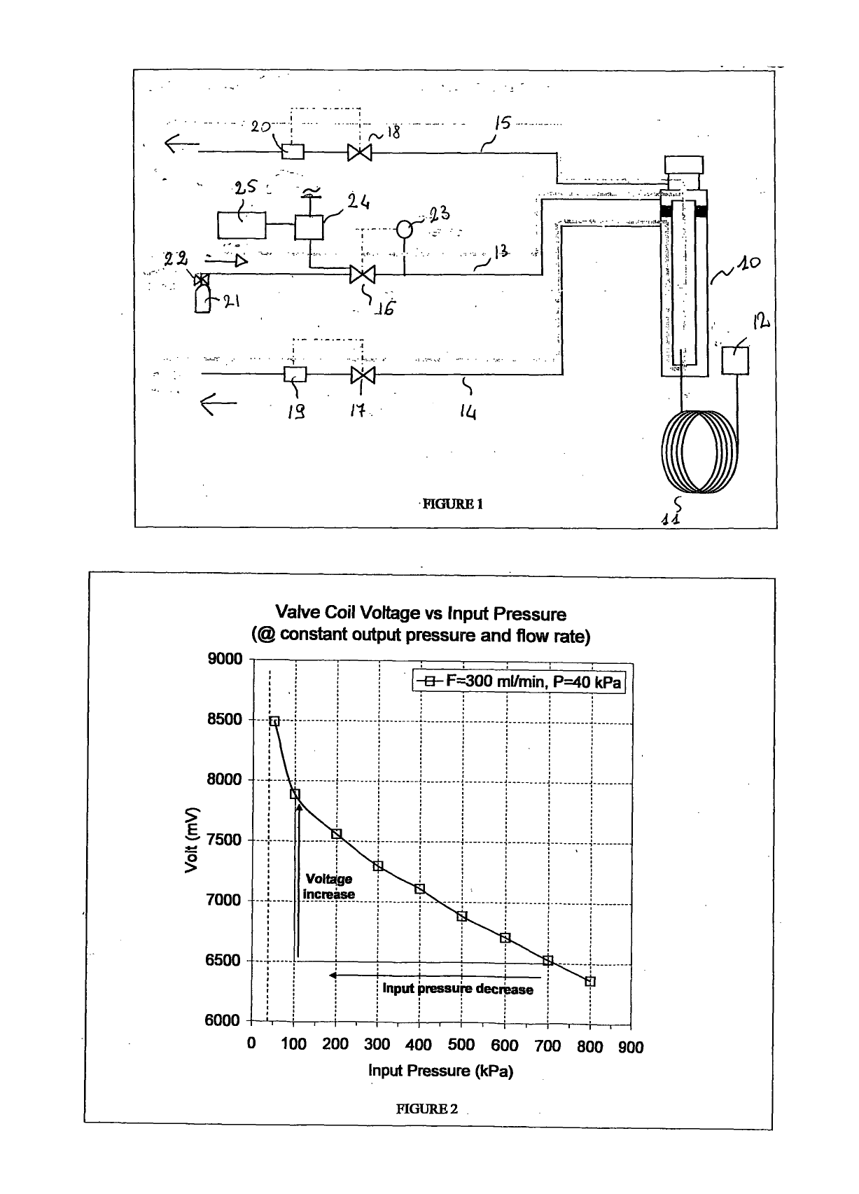

Referring now to FIG. 1, a conventional gas chromatographic instrument is diagrammatically formed by an injector 10, a column 11 housed in a oven (not shown) and a detector 12. The injector 10 is for instance of the vaporisation and split/splitless type.

Accordingly three gas lines are connected to said injector 10, namely a carrier gas feeding line 13, a split output line 14 and a septum purge output line 15. Each line is controlled by a proportional solenoid valve, respectively 16, 17 and 18. The valves 17 and 18 are connected with flow sensors 19 and 20, for instance placed downstream the valves, to control the split output flow and the purge output flow.

The line 13 is fed by a cylinder 21 containing carrier gas under pressure and having its own valve 22, or by a suitable gas generator (not shown) Valve 16 usually operates with a pressure sensor 23 placed downstream and is electrically fed by a controller 24. Valve 16 is controlled in a way that the desired pressure (column head pressure) is maintained into the injector and consequently a desired column flow is achieved. Flow rate delivered by the proportional valve 16 is depending by the voltage applied to the coil and by the pressure drop across the valve. In fact, as the proportional valve 16 works as variable orifice (variable flow restrictor), the flow rate through the orifice will depend from the pressure drop across the same.

In a closed loop the valve voltage is controlled to substantially maintain the delivered flow constant (this flow being equal to purge flow +split flow +column flow). If the input pressure to the valve changes, the related control circuit will automatically modify the voltage applied to the valve to maintain the desired flow.

FIG. 2 shows what above, i.e. how the voltage applied to a proportional valve changes when the input pressure to the same changes. This valve can be the proportional valve 16 in the schematic of FIG. 1, wherein the column head pressure was set and maintained at 40 kPa while the total flow (split +purge +column) was set at 300 ml/min.

To maintain the column head pressure of 40 kPa and the total flow of 300 ml/min when input pressure decreases from 800 kPa (8 bar) to 100 kPa (1 bar) the voltage supplied to the proportional valve changes from around 6.5 to 8.0 Volts. This is exactly the situation of a cylinder getting empty. Of course when the input pressure will decrease below the set pressure of 40 kPa the valve will not be able anymore to deliver the required flow and the GC system will enter an error situation. However this may be too late and input pressure may drop to zero before the operator may be able to replace the cylinder.

The invention consists in a way of monitoring the voltage of the proportional valve to recognize that the cylinder is near to be empty. As in the example of FIG. 2 a threshold can be set, e.g. at 7.0 Volt, and when voltage reaches this value a message is displayed on the alarm 25 or the GC computer to alert the operator that the gas line will shortly reach an unsuitable pressure and that the cylinder 21 should be replaced.

Anticipating the error situation the operator will have much more time to do the cylinder replacement operations without interrupting the operation of the GC. In other words the measure of the voltage of the valve is used as an indirect measure of the input pressure and the input pressure measure is used to alert the operator when it gets too low.

Of course changing selected operating pressure and flow will also change applied voltage to the valve, so this threshold should be dynamic and automatically reset when operating conditions are changed.

Note that the same control could be applied to auxiliary gases used in a GC instrument, for instance the gas used to operate the detector(s).

1. A method to detect a gas feeding low pressure condition in a gas chromatographic instrument having a gas line fed by a cylinder or a generator and comprising a proportional solenoid valve to control the gas pressure and/or flow rate to the instrument, said method being characterized by monitoring an electric parameter applied to said proportional solenoid valve and by providing an alarm to the operator when said parameter reaches a pre-set value.

2. A method according to claim 1 wherein said pre-set value is set according to the instrument operating conditions.

3. A method according to claim 1, wherein said electric parameter is the voltage applied to said proportional solenoid valve.

4. A method according to claim 1, wherein said electric parameter is the current applied to said proportional solenoid valve.

5. A method according to claim 1, wherein said gas is carrier gas.

6. A method according to one of claims 1, wherein said gas is the gas operating the detector(s).

7. A gas chromatographic instrument comprising a gas feeding line fed by a cylinder or a generator and having a proportional solenoid valve to control the gas feeding pressure and/or flow rate to the instrument, characterized in that it comprises a detector for monitoring an electric parameter applied to said proportional solenoid valve and alarm means adapted to operate when a pre-set value of said electric parameter is reached.

8. An instrument according to claim 7, wherein means are provided to modify at will said pre-set value of said electric parameter.

9. An instrument according to claim 7, wherein said proportional solenoid valve operates in a closed loop with a pressure sensor acting downstream said valve.

10. An instrument according to claim 7, wherein said gas is carrier gas.

11. An instrument according to claim 7, wherein said gas is that used to operate the chromatograph detector(s).
